(19) United States
(12) Patent Application Publication
(10) Pub. No.: US 2025/0270045 A1
(43) Pub. Date: Aug. 28, 2025

(54) POSITION DISPLAY METHOD, PICKING ROBOT, AND STORAGE MEDIUM

(71) Applicant: Beijing Youzhuju Network Technology Co., Ltd., Beijing (CN)

(72) Inventors: Linge ZHANG, Beijing (CN); Yin YIN, Beijing (CN)

(21) Appl. No.: 19/033,383

(22) Filed: Jan. 21, 2025

(30) Foreign Application Priority Data
Feb. 27, 2024 (CN) 202410218539.8

(51) Int. Cl. B65G 1/137; G06Q 10/087

(52) U.S. Cl. CPC B65G 1/1375; G06Q 10/087; B65G 2209/04; B65G 2209/06

(57) ABSTRACT

A position display method, a picking robot, and a storage medium are provided. The method includes: obtaining a picking task, and determining, based on the picking task, an item to be picked, where the picking robot includes at least one container for carrying the item to be picked, the picking robot moves between a plurality of shelves in a warehouse to transport items, the shelf includes a plurality of goods storage compartments for storing different items respectively, and the item to be picked is an item that needs to be manually picked; determining a robot position of the picking robot between the shelves and a compartment position of the goods storage compartment where the item to be picked is located; and displaying, in a preset display interface of the picking robot, a relative position relationship between the compartment position and the robot position.

This application claims the priority to and benefits of the Chinese Patent Application, No. 202410218539.8, which was filed on Feb. 27, 2024. The aforementioned patent application is hereby incorporated by reference in its entirety.

### TECHNICAL FIELD

Embodiments of the present disclosure relate to computer application technologies, and in particular, to a position display method, a picking robot, and a storage medium.

### BACKGROUND

In the field of logistics and warehousing, the application of picking robots effectively increases efficiency in warehouse management, reduces labor costs, and improves the security of picking work. Moreover, the picking robots also have good scalability, and sorting operations in a warehouse that meet different scales and needs may be customized and adjusted according to actual conditions of the warehouse. Therefore, the use of picking robots and manual cooperation in picking is one of the important development directions in the field of modern logistics and warehousing.

Generally, a variety of items are stored in a warehouse. The placement of the items in the warehouse is often manually set, and there is basically no fixed rule to follow. In the related art, when a picking robot executes a picking task, the picking robot is controlled to move to and then stay at a point near an item, waiting for manual picking. However, there may be a plurality of shelves around the position at which the picking robot stays, which makes it difficult for a picker to quickly locate an item to be picked. In particular, a picker who is not familiar with the placement of items may need to check shelves around the picking robot one by one to locate the item to be picked, which leads to low picking efficiency.

### SUMMARY

The present disclosure provides a position display method, a picking robot, and a storage medium, to enable a storage position of an item to be intuitively displayed, thereby improving the efficiency of item picking.

According to a first aspect, an embodiment of the present disclosure provides a position display method. The method includes:
obtaining a picking task that is being executed by the picking robot, and determining, based on the picking task, an item to be picked, where the picking robot includes at least one container for carrying the item to be picked, the picking robot moves between a plurality of shelves in a warehouse to transport items, the shelf includes a plurality of goods storage compartments for storing different items respectively, and the item to be picked is an item that needs to be manually picked;
determining a robot position of the picking robot between the shelves and a compartment position of the goods storage compartment where the item to be picked is located; and
displaying, in a preset display interface of the picking robot, a relative position relationship between the compartment position and the robot position.

According to a second aspect, an embodiment of the present disclosure further provides a position display apparatus. The apparatus includes:
an item determination module configured to obtain a picking task that is being executed by the picking robot, and determine, based on the picking task, an item to be picked, where the picking robot includes at least one container for carrying the item to be picked, the picking robot moves between a plurality of shelves in a warehouse to transport items, the shelf includes a plurality of goods storage compartments for storing different items respectively, and the item to be picked is an item that needs to be manually picked;
a position determination module configured to determine a robot position of the picking robot between the shelves and a compartment position of the goods storage compartment where the item to be picked is located; and
a position display module configured to display, in a preset display interface of the picking robot, a relative position relationship between the compartment position and the robot position.

According to a third aspect, an embodiment of the present disclosure further provides a picking robot. The picking robot includes:
one or more processors; and
a storage apparatus configured to store one or more programs, where
the one or more programs, when executed by the one or more processors, cause the one or more processors to implement the position display method according to any one of the embodiments of the present disclosure.

According to a fourth aspect, an embodiment of the present disclosure further provides a storage medium containing computer-executable instructions, where the computer-executable instructions, when executed by a computer processor, are used to perform the position display method according to any one of the embodiments of the present disclosure.

According to the technical solutions of the embodiments of the present disclosure, first, the picking task that is being executed by the picking robot is obtained and the item to be picked is determined based on the picking task, such that the item to be picked that needs to be transported by the picking robot by moving between the plurality of shelves in the warehouse can be accurately determined. Then, the robot position of the picking robot between the shelves and the compartment position of the goods storage compartment where the item to be picked is located are determined, such that the relative position relationship between the compartment position and the robot position may be obtained. Finally, the relative position relationship between the compartment position and the robot position is displayed in the preset display interface of the picking robot, which solves the technical problems that it is difficulty for a picker to locate items during picking and there is low picking efficiency, and enables storage positions of the items to be intuitively displayed, such that the picker learns the storage positions of the items of the picking robot in a timely, convenient, and intuitive manner, and then may quickly identify the storage position of the item to be picked, thereby improving the efficiency of item picking.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a schematic flowchart of a position display method according to an embodiment of the present disclosure;

FIG. 2 is a scenario diagram of item picking applicable to a position display method according to an embodiment of the present disclosure;

FIG. 3 is a schematic diagram of a preset display interface of a picking robot applicable to a position display method according to an embodiment of the present disclosure;

FIG. 4 is a schematic flowchart of another position display method according to an embodiment of the present disclosure;

FIG. 5 is a schematic flowchart of another position display method according to an embodiment of the present disclosure;

FIG. 6 is a schematic diagram of a structure of a position display apparatus according to an embodiment of the present disclosure; and

FIG. 7 is a schematic diagram of a structure of a picking robot according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It may be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It may be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It may be understood that the data involved in the technical solutions (including, but not limited to, the data itself and the access to or use of the data) shall comply with the requirements of corresponding laws, regulations, and relevant provisions.

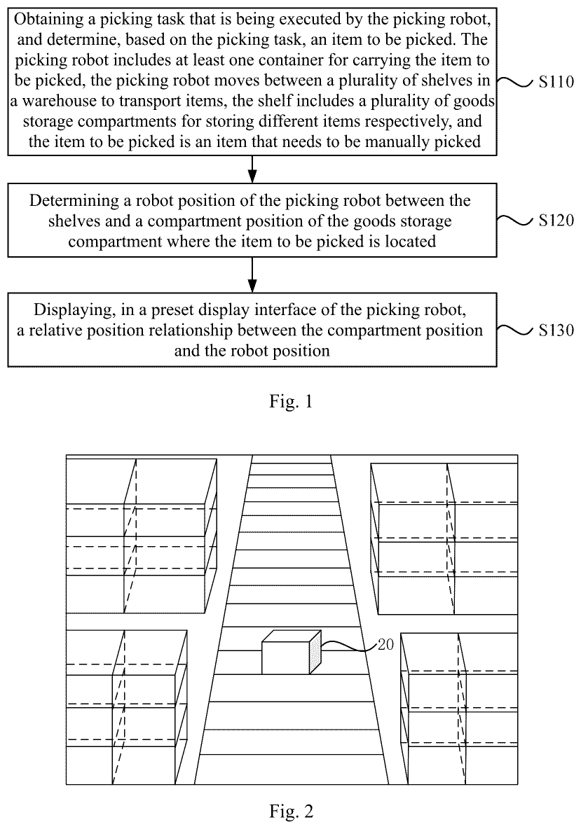

FIG. 1 is a schematic flowchart of a position display method according to an embodiment of the present disclosure. This embodiment of the present disclosure is applicable to a case where picking of items located on shelves in a warehouse is performed. The method may be performed by a position display apparatus, which may be implemented in the form of software and/or hardware, and optionally, by an electronic device provided on or integrated into a picking robot. The electronic device may be an external control terminal or a robot control processing chip, etc.

As shown in FIG. 1, the method in this embodiment may specifically include the following steps.

S110: Obtaining a picking task that is being executed by the picking robot, and determine, based on the picking task, an item to be picked. The picking robot includes at least one container for carrying the item to be picked, the picking robot moves between a plurality of shelves in a warehouse to transport items, the shelf includes a plurality of goods storage compartments for storing different items respectively, and the item to be picked is an item that needs to be manually picked.

The picking task may be understood as a process of obtaining, according to requirements of one or more picking orders, an item to be picked that corresponds to the picking order from a goods storage compartment on a shelf in the warehouse, placing the item into a designated container, and transporting the item to a target position. Item information in the picking order may include, but is not limited to, an item identifier and an item quantity of the item to be picked, that is, the picking task may include the item identifier and the item quantity of the item to be picked. The item identifier may be used to distinguish different items. The item identifier may include an item name. In addition, the item identifier may further include information such as an item category. There may be one or more items, and the specific quantity of the items may be determined based on the picking task. Optionally, the shelf may be a grid shelf. In this embodiment of the present disclosure, obtaining the picking task of the picking robot may include: determining a picking order assigned to the picking robot, and obtaining the picking task of the picking robot based on the picking order.

In this embodiment of the present disclosure, obtaining the picking task of the picking robot based on the picking order may be performed in various ways, which are not specifically limited herein. For example, when there is one picking order, the item information in the picking order may be determined, and then the picking task of the picking robot may be obtained based on the item information. For example, the item identifier in the picking order may include a first item and a second item, where an item quantity of the first item is five and an item quantity of the second item is one. In this case, the picking task may be to pick five first items and to pick one second item.

When there are a plurality of picking orders, statistics on item information in the picking orders may be collected, and then the picking task of the picking robot may be obtained based on the statistical item information, which enables unified picking of the items in the plurality of picking orders, thereby increasing the speed of handling the picking orders. Exemplarily, the picking order may include a first order and a second order, where item information in the first order may include five first items and three second items, and item information in the second order may include three first items and one third item. Then, the statistical item information includes eight first items, three second items, and one third item. It can be learned that the picking task in this case may be to pick eight first item, three second items, and one third item.

When there are a plurality of picking orders, a current order to be handled may be determined from the plurality of picking orders, and then the picking task of the picking robot is obtained based on item information in the current order to be handled. Optionally, the determining the current order to be handled from the plurality of picking orders may be randomly selecting a picking order from the plurality of picking orders as the current order to be handled. Alternatively, the determining the current order to be handled from the plurality of picking orders may be determining a sequential order in which the picking orders are to be handled, and determining, according to the sequential handling order, the current order to be handled from the plurality of picking orders.

In this embodiment of the present disclosure, the determining, based on the picking task, an item to be picked may include: determining a picking order corresponding to the picking task. Thus, the item to be picked may be determined based on item information, such as an item identifier, in the picking order.

In this embodiment of the present disclosure, the picking robot may include one or more containers for carrying an item to be picked. As an optional implementation of this embodiment of the present disclosure, when the picking robot includes one container, the container may be used to carry all items to be picked in the picking task.

As another optional implementation of this embodiment of the present disclosure, when the picking robot includes a plurality of containers, each container may be pre-assigned a picking order corresponding to the container, so that the container carries an item to be picked in the picking order that corresponds to the container. Optionally, assigning a picking order to each container may be performed specifically by: determining an idle container, where the idle container may be understood as a container to which no picking order has been assigned; and then randomly assigning a picking order to the idle container. Such handling can improve the efficiency in picking the item and the efficiency in handling the picking orders. It should be noted that different containers may have the same or different quantities of picking orders assigned thereto.

As another optional implementation of this embodiment of the present disclosure, when the picking robot includes a plurality of containers, a corresponding item list may be preset for each container, where the item list includes items that the container may carry. Then, each container may be used to carry items in the item list corresponding to the container. It should be noted that different containers may correspond to the same or different item lists. In addition, different item lists may have the same or different item categories. It should also be noted that when the picking robot includes a plurality of containers, different containers may have the same or different item carrying capacities.

S120: Determining a robot position of the picking robot between the shelves and a compartment position of the goods storage compartment where the item to be picked is located.

The robot position may be understood as a position at which the picking robot stays between the shelves. The compartment position may be understood as a position of the compartment for storing the item on a shelf. The compartment position may be used to accurately determine the compartment where the item is located. Exemplarily, the compartment position may be a position of a compartment located in the third column and the fifth layer on a certain shelf.

In this embodiment of the present disclosure, the robot position of the picking robot between the shelves may be determined in various ways. For example, it may be determined by capturing images of the picking robot between the shelves using a camera installed in the warehouse, and then analyzing and processing the captured images, to obtain the robot position of the picking robot between the shelves. Alternatively, it may be determined by installing an obstacle detection apparatus between the shelves, such that the robot position of the picking robot between the shelves may be determined by the obstacle detection apparatus. Still alternatively, it may be determined by installing a locating apparatus in the picking robot, such that the robot position of the picking robot between the shelves may be determined based on position information from the locating apparatus.

In this embodiment of the present disclosure, the compartment position of the goods storage compartment where the item to be picked is located may be determined in various ways. As an optional implementation of the embodiments of the present disclosure, first item storage information about the warehouse is obtained, where the first item storage information includes all items in the warehouse and compartment positions of goods storage compartments where the items are located. The compartment position of the goods storage compartment where the item to be picked is located may be determined based on the first item storage information. It may be understood that the first item storage information may be understood as storage information of the items in the warehouse. This technical solution makes it possible to accurately identify the compartment position of the item to be picked on the shelf in the warehouse based on the obtained storage information of the items in the warehouse.

As another optional implementation of the embodiments of the present disclosure, a correspondence between shelves and items in the warehouse is obtained to determine a shelf where the item to be picked is located. Second item storage information about the shelf is obtained, where the second item storage information includes compartment positions of goods storage compartments where the items stored on the shelf are located, Thus, a compartment for the item to be picked on the shelf, that is, the goods storage compartment, may be determined based on the second item storage information, and then the compartment position of the goods storage compartment may be obtained. It may be understood that the second item storage information may be understood as storage information of the items on the shelf in the warehouse. According to this technical solution, first, the shelf where the item to be picked is located is preliminarily determined, and then, the compartment position for the item to be picked on the shelf may be quickly and conveniently identified based on the storage information of the items on the shelf.

S130: Displaying, in a preset display interface of the picking robot, a relative position relationship between the compartment position and the robot position.

The preset display interface may be understood as a display interface that is preset on the picking robot, which may be used to display the relative position relationship between the compartment position and the robot position. In addition, the preset display interface may also be used to display information about items currently being picked, information about items to be picked, information about unpicked items, and information about picked items. In the embodiments of the present disclosure, an interface style (e.g., an interface size, an interface shape, etc.) of the preset display interface may be set according to actual needs, which is not specifically limited herein. In this embodiment of the present disclosure, the relative position relationship may be a position relationship of the compartment position relative to the robot position with the robot position as a reference position, or may be a positional relationship of the robot position relative to the compartment position with the compartment position as a reference position.

For example, after the robot position of the picking robot between the shelves and the compartment position of the goods storage compartment where the item to be picked is located are obtained, the relative position relationship between the compartment position and the robot position may be obtained based on the compartment position and the robot position. After the positional relationship is obtained, the position relationship may be displayed in the preset display interface of the picking robot.

In this embodiment of the present disclosure, the relative position relationship may include orientation information of the compartment position relative to the robot position. The displaying a relative position relationship between the compartment position and the robot position may include: determining, based on the robot position and the compartment position, the orientation information of the compartment position relative to the robot position; and displaying, in the preset display interface of the picking robot, orientation prompt information corresponding to the orientation information.

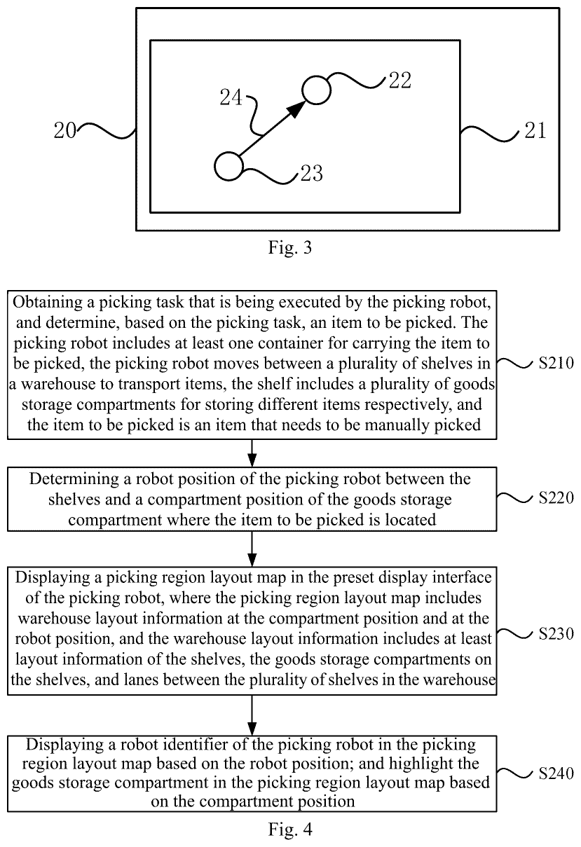

The orientation information may be orientation information of the compartment position relative to the robot position with the robot position as a reference position. Optionally, the orientation prompt information may include orientation prompt text and/or an orientation prompt pattern. Exemplarily, the orientation prompt text may indicate a position of a compartment located in the sixth column and the fifth layer on the left-side shelf of the compartment position relative to the robot position. The orientation prompt pattern may be used to indicate an orientation of the compartment position relative to the robot position. Optionally, the orientation prompt pattern may include an orientation indication arrow. The orientation indication arrow in the orientation prompt pattern may be a single orientation indication arrow, or may be a plurality of orientation indication arrows in succession. A pattern style of the orientation prompt pattern may be set according to actual needs, which is not specifically limited herein. A display style (e.g., color, size, etc.) of the orientation indication arrow may be set according to actual needs, which is not specifically limited herein. Referring to FIG. 2 and FIG. 3, a picking robot 20 moves between a plurality of shelves in a warehouse for item picking. During the item picking, an orientation indication arrow 24 between a compartment position 22 and a robot position 23 is displayed in a preset display interface 21 of the picking robot 20.

In this embodiment of the present disclosure, the determining, based on the robot position and the compartment position, the orientation information of the compartment position relative to the robot position may include: planning movement path information for moving from the robot position to the compartment position based on the robot position and the compartment position; and then determining the orientation information of the compartment position relative to the robot position based on the movement path information.

According to the technical solutions of the embodiments of the present disclosure, first, the picking task that is being executed by the picking robot is obtained and the item to be picked is determined based on the picking task, such that the item to be picked that needs to be transported by the picking robot by moving between the plurality of shelves in the warehouse can be accurately determined. Then, the robot position of the picking robot between the shelves and the compartment position of the goods storage compartment where the item to be picked is located are determined, such that the relative position relationship between the compartment position and the robot position may be obtained. Finally, the relative position relationship between the compartment position and the robot position is displayed in the preset display interface of the picking robot, which solves the technical problems that it is difficulty for a picker to locate items during picking and there is low picking efficiency, and enables storage positions of the items to be intuitively displayed, such that the picker learns the storage positions of the items of the picking robot in a timely, convenient, and intuitive manner, and then may quickly identify the storage position of the item to be picked, thereby improving the efficiency of item picking.

FIG. 4 is a schematic flowchart of another position display method according to an embodiment of the present disclosure. On the basis of the above embodiments, the technical solution of this embodiment further refines the display of the relative position relationship between the compartment position and the robot position in the preset display interface of the picking robot. Optionally, the displaying, in a preset display interface of the picking robot, a relative position relationship between the compartment position and the robot position includes: displaying a picking region layout map in the preset display interface of the picking robot, where the picking region layout map includes warehouse layout information at the compartment position and at the robot position, and the warehouse layout information includes at least layout information of the shelves, the goods storage compartments on the shelves, and lanes between the plurality of shelves in the warehouse; displaying a robot identifier of the picking robot in the picking region layout map based on the robot position; and highlighting the goods storage compartment in the picking region layout map based on the compartment position. For a specific implementation, reference may be made to the description of this embodiment. Details about technical features that are the same as or similar to those in the foregoing embodiment are not repeated herein.

As shown in FIG. 4, the method in this embodiment may specifically include the following steps.

S210: Obtaining a picking task that is being executed by the picking robot, and determine, based on the picking task, an item to be picked. The picking robot includes at least one container for carrying the item to be picked, the picking robot moves between a plurality of shelves in a warehouse to transport items, the shelf includes a plurality of goods storage compartments for storing different items respectively, and the item to be picked is an item that needs to be manually picked.

S220: Determining a robot position of the picking robot between the shelves and a compartment position of the goods storage compartment where the item to be picked is located.

S230: Displaying a picking region layout map in the preset display interface of the picking robot, where the picking region layout map includes warehouse layout information at the compartment position and at the robot position, and the warehouse layout information includes at least layout information of the shelves, the goods storage compartments on the shelves, and lanes between the plurality of shelves in the warehouse.

For example, after the robot position of the picking robot between the shelves and the compartment position of the goods storage compartment where the item to be picked is located are determined, the picking region layout map may be obtained based on the robot position and the compartment position. After the picking region layout map is obtained, the picking region layout map may be displayed in the preset display interface of the picking robot.

In this embodiment of the present disclosure, the displaying the picking region layout map in the preset display interface of the picking robot may include: when the size of the picking region layout map does not match the size of the preset display interface, for example, the size of the picking region layout map is larger than the size of the preset display interface, or the size of the picking region layout map is smaller than the size of the preset display interface, etc., performing image processing on the picking region layout map based on the size of the preset display interface. A zoomed picking region layout map is then displayed in the preset display interface of the picking robot. The image processing may include at least one of image reduction processing, image enlargement processing, and image cropping processing.

As an optional implementation of the embodiments of the present disclosure, before the displaying the picking region layout map, the method may further include: obtaining a warehouse layout map of the warehouse where the picking robot is located, and using the warehouse layout map as the picking region layout map. The warehouse layout map may be a two-dimensional view of the warehouse layout, or may be a three-dimensional view of the warehouse layout, which is not specifically limited herein. In this technical solution, using the entire layout map of the warehouse as the picking region layout map, the warehouse layout may be reflected from the overall layout of the warehouse.

As another optional implementation of the embodiments of the present disclosure, before the displaying the picking region layout map, the method may further include: determining a target picking region based on the compartment position and/or the robot position; and obtaining a warehouse layout map of the warehouse where the picking robot is located; and after the target picking region and the warehouse layout map are determined, determining a local layout map corresponding to the target picking region in the warehouse layout map. Thus, the local layout map corresponding to the target picking region in the warehouse layout map may be used as the picking region layout map.

The target picking region may be understood as a region in the warehouse where the item to be picked needs to be picked based on the compartment position and/or the robot position. In this embodiment of the present disclosure, the determining a target picking region based on the compartment position and/or the robot position may include at least one of the following operations: determining, as the target picking region, a region of a first preset size centered at the compartment position in the warehouse; determining, as the target picking region, a region of a second preset size centered at the robot position in the warehouse; and determining a core region from the warehouse with the compartment position and the robot position as boundary points, and expanding the core region to obtain the target picking region.

The first preset size may be understood as a preset size centered at the compartment position in the warehouse, and the value thereof may be set according to actual situations, for example, it may be set to 10 meters. The second preset size may be understood as a preset size centered at the robot position in the warehouse, and the value thereof may be set according to actual situations, for example, it may be set to 8 meters. It should be noted that the first preset size may be the same as or different from the second preset size, which is not specifically limited herein. The shape of the core region may be set according to actual needs, and the shape thereof is not specifically limited herein, for example, it may be set to a triangle, a rectangle, a circle, an irregular shape, etc. That is, the shape of the target picking region may be set according to actual needs.

S240: Displaying a robot identifier of the picking robot in the picking region layout map based on the robot position; and highlight the goods storage compartment in the picking region layout map based on the compartment position.

A specific presentation style of the robot identifier may be set according to actual needs, which is not specifically limited herein, and may include at least one of a preset graphic, text, letter, or number. The robot identifier may be used to distinguish different picking robots. In this embodiment of the present disclosure, the displaying a robot identifier of the picking robot in the picking region layout map based on the robot position may include: determining, based on the robot position, a robot identifier of a picking robot located at the robot position. After the robot identifier is determined, the robot identifier may be displayed in the picking region layout map.

In this embodiment of the present disclosure, the highlighting the goods storage compartment in the picking region layout map based on the compartment position may include: determining, based on the compartment position, a goods storage compartment corresponding to the compartment position in the picking region layout map. After the goods storage compartment is determined, the goods storage compartment in the picking region layout map may be highlighted in a preset highlighting manner. Optionally, the preset highlighting manner may include a preset color and/or a preset ratio. It should be noted that the preset color may be set according to actual needs, and the color is not specifically limited herein, for example, it may be set to red, yellow, orange, etc. The preset ratio may be a ratio set with the size of the goods storage compartment in the picking region layout map as a reference, and the ratio is not specifically limited herein, for example, it may be set to 1:2, 1:1, 3:2, etc.

As an optional implementation of the embodiments of the present disclosure, the highlighting the goods storage compartment in the picking region layout map may include: when the picking region local map is a two-dimensional picking region local map, determining a goods storage compartment corresponding to the compartment position in the two-dimensional picking region local map, and highlighting the goods storage compartment in a preset color. In addition, prompt information for the compartment position may be displayed in the form of text at a highlighted position in the picking region local map.

As another optional implementation of the embodiments of the present disclosure, the highlighting the goods storage compartment in the picking region layout map may include: when the picking region local map is a three-dimensional picking region local map, determining a goods storage compartment corresponding to the compartment position in the three-dimensional picking region local map. After the goods storage compartment is determined, the goods storage compartment may be displayed in a preset ratio and/or a preset color in the three-dimensional picking region local map, to intuitively display the storage position of the item.

Optionally, each of the goods storage compartments on the shelf may be marked with a compartment identifier. On this basis, the compartment identifier of the goods storage compartment may further be displayed in the preset display interface of the picking robot. Such a setting has an advantage of allowing the picker to check whether a located goods storage compartment is consistent with the indicated goods storage compartment. This technical solution is particularly suitable for situations where a plurality of goods storage compartments store items with similar appearance, and can reduce the risk of picking errors due to incorrect recognition of an orientation by the picker.

According to the technical solutions of the embodiments of the present disclosure, first, the picking region layout map is displayed in the preset display interface of the picking robot, where the picking region layout map includes the warehouse layout information at the compartment position and at the robot position, and the warehouse layout information includes at least the layout information of the shelves, the goods storage compartments on the shelves, and the lanes between the plurality of shelves in the warehouse. This technical solution can provide effective guidance to the picker by providing the picking region layout map that intuitively and realistically displays the layout of the warehouse. Then, the robot identifier of the picking robot is displayed in the picking region layout map based on the robot position. Furthermore, the goods storage compartment is highlighted in the picking region layout map based on the compartment position. Therefore, the robot identifier of the picking robot and the goods storage compartment are intuitively displayed in the picking region layout map, and the position of the picking robot in the warehouse and the position of the item to be picked on the shelf may be accurately identified, thereby improving the efficiency in picking the item.

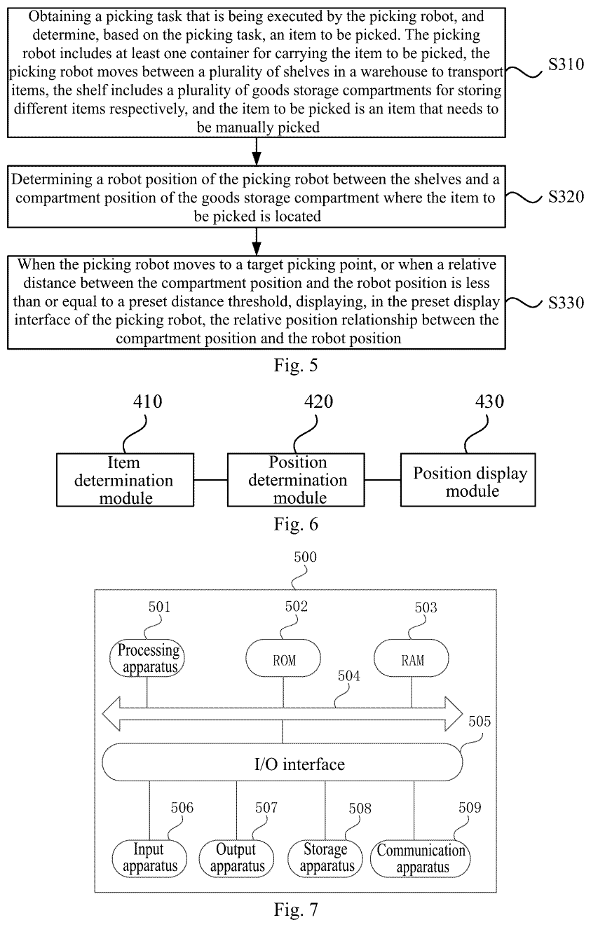

FIG. 5 is a schematic flowchart of another position display method according to an embodiment of the present disclosure. On the basis of the above embodiments, the technical solution of this embodiment further refines the display of the relative position relationship between the compartment position and the robot position in the preset display interface of the picking robot. Optionally, the displaying, in a preset display interface of the picking robot, a relative position relationship between the compartment position and the robot position includes: when the picking robot moves to a target picking point, or when a relative distance between the compartment position and the robot position is less than or equal to a preset distance threshold, displaying, in the preset display interface of the picking robot, the relative position relationship between the compartment position and the robot position. For a specific implementation, reference may be made to the description of this embodiment. Details about technical features that are the same as or similar to those in the foregoing embodiment are not repeated herein.

As shown in FIG. 5, the method in this embodiment may specifically include the following steps.

S310: Obtaining a picking task that is being executed by the picking robot, and determine, based on the picking task, an item to be picked. The picking robot includes at least one container for carrying the item to be picked, the picking robot moves between a plurality of shelves in a warehouse to transport items, the shelf includes a plurality of goods storage compartments for storing different items respectively, and the item to be picked is an item that needs to be manually picked.

S320: Determining a robot position of the picking robot between the shelves and a compartment position of the goods storage compartment where the item to be picked is located.

S330: When the picking robot moves to a target picking point, or when a relative distance between the compartment position and the robot position is less than or equal to a preset distance threshold, displaying, in the preset display interface of the picking robot, the relative position relationship between the compartment position and the robot position.

The target picking point may be understood as a position in the warehouse at which the item to be picked needs to be picked, that is, a position at which the picking robot stays. The preset distance threshold may be understood as a threshold preset for the distance between the compartment position and the robot position, and the value thereof is not specifically limited herein, for example, it may be set to 8 meters, 5 meters, 3 meters, etc. With this technical solution, the relative position relationship between the compartment position and the robot position may be displayed in the preset display interface of the picking robot in a more intelligent and personalized manner, to effectively guide the picker to accurately locate the item to be picked, thereby improving the picking efficiency.

As an optional implementation of the embodiments of the present disclosure, when the picking robot moves to the target picking point, the relative position relationship between the compartment position and the robot position may be displayed in the preset display interface of the picking robot. For example, a picking point that the picking robot needs to reach, i.e., the target picking point, is determined. Position data of the picking robot is obtained. When the picking robot stays at the position data for a preset duration and the position data is the target picking point, it may be determined that the picking robot has moved to the target picking point. In this case, the relative position relationship between the compartment position and the robot position may then be displayed in the preset display interface of the picking robot. In the embodiments of the present disclosure, the target picking point of the picking robot may be determined by: obtaining movement path information of the picking robot in the warehouse; and then determining the target picking point of the picking robot based on the compartment position, the robot position, and the movement path information.

As another optional implementation of the embodiments of the present disclosure, when the relative distance between the compartment position and the robot position is less than or equal to the preset distance threshold, the relative position relationship between the compartment position and the robot position may be displayed in the preset display interface of the picking robot. For example, during the process of the picking robot moving along a preset path at a preset speed, the robot position of the picking robot is obtained in real time. Thus, the relative distance between the compartment position and the robot position may be calculated based on the robot position and the compartment position. After the relative distance is obtained, the relative distance may be compared with the preset distance threshold. When the relative distance between the compartment position and the robot position is less than or equal to the preset distance threshold, the relative position relationship between the compartment position and the robot position may be determined based on the compartment position and the robot position. Then, the relative position relationship may be displayed in the preset display interface of the picking robot. It can be understood that when the relative distance between the compartment position and the robot position is greater than the preset distance threshold, the relative position relationship between the compartment position and the robot position may not be displayed in the preset display interface of the picking robot.

According to the technical solutions of the embodiments of the present disclosure, when the picking robot moves to the target picking point or when the relative distance between the compartment position and the robot position is less than or equal to the preset distance threshold, the relative position relationship between the compartment position and the robot position is displayed in the preset display interface of the picking robot, which enables the function of displaying the relative position relationship in the preset display interface of the picking robot in a more intelligent and personalized manner.

FIG. 6 is a schematic diagram of a structure of a position display apparatus according to an embodiment of the present disclosure. As shown in FIG. 6, the apparatus includes an item determination module 410, a position determination module 420, and a position display module 430.

The item determination module 410 is configured to obtain a picking task that is being executed by the picking robot, and determine, based on the picking task, an item to be picked. The picking robot includes at least one container for carrying the item to be picked, the picking robot moves between a plurality of shelves in a warehouse to transport items, the shelf includes a plurality of goods storage compartments for storing different items respectively, and the item to be picked is an item that needs to be manually picked. The position determination module 420 is configured to determine a robot position of the picking robot between the shelves and a compartment position of the goods storage compartment where the item to be picked is located. The position display module 430 is configured to display, in a preset display interface of the picking robot, a relative position relationship between the compartment position and the robot position.

According to the technical solutions of the embodiments of the present disclosure, first, the item determination module is used to obtain the picking task that is being executed by the picking robot, and determine, based on the picking task, the item to be picked, such that the item to be picked that needs to be transported by the picking robot by moving between the plurality of shelves in the warehouse can be accurately determined, where the picking robot includes at least one container for carrying the item to be picked, the picking robot moves between a plurality of shelves in a warehouse to transport items, the shelf includes a plurality of goods storage compartments for storing different items respectively, and the item to be picked is an item that needs to be manually picked; the position determination module is used to determine the robot position of the picking robot between the shelves and the compartment position of the goods storage compartment where the item to be picked is located, such that the relative position relationship between the compartment position and the robot position may be obtained; and the position display module is used to display the relative position relationship between the compartment position and the robot position in the preset display interface of the picking robot, which solves the technical problems that it is difficulty for a picker to locate items during picking and there is low picking efficiency, and enables storage positions of the items to be intuitively displayed, such that the picker learns the storage positions of the items of the picking robot in a timely, convenient, and intuitive manner, and then may quickly identify the storage position of the item to be picked, thereby improving the efficiency of item picking.

On the basis of the above optional technical solutions, optionally, the position display module 430 includes a picking region layout map display unit and a position display unit.

The picking region layout map display unit is configured to display a picking region layout map in the preset display interface of the picking robot, where the picking region layout map includes warehouse layout information at the compartment position and at the robot position, and the warehouse layout information includes at least layout information of the shelves, the goods storage compartments on the shelves, and lanes between the plurality of shelves in the warehouse.

The position display unit is configured to display a robot identifier of the picking robot in the picking region layout map based on the robot position, and highlight the goods storage compartment in the picking region layout map based on the compartment position.

On the basis of the above optional technical solutions, optionally, the apparatus further includes a first picking region layout map determination module configured to: before the picking region layout map is displayed, determine a target picking region based on the compartment position and/or the robot position; and obtain a warehouse layout map of the warehouse where the picking robot is located, and use, as the picking region layout map, a local layout map corresponding to the target picking region in the warehouse layout map.

On the basis of the above optional technical solutions, optionally, the determining a target picking region based on the compartment position and/or the robot position includes at least one of the following operations: determining, as the target picking region, a region of a first preset size centered at the compartment position in the warehouse; determining, as the target picking region, a region of a second preset size centered at the robot position in the warehouse; and determining a core region from the warehouse with the compartment position and the robot position as boundary points, and expanding the core region to obtain the target picking region.

On the basis of the above optional technical solutions, optionally, the apparatus further includes a second picking region layout map determination module configured to, before the picking region layout map is displayed, obtain a warehouse layout map of the warehouse where the picking robot is located, and use the warehouse layout map as the picking region layout map.

On the basis of the above optional technical solutions, optionally, the relative position relationship includes orientation information of the compartment position relative to the robot position. The position display module 430 is configured to: determine, based on the robot position and the compartment position, the orientation information of the compartment position relative to the robot position; and display, in the preset display interface of the picking robot, orientation prompt information corresponding to the orientation information.

On the basis of the above optional technical solutions, optionally, the orientation prompt information includes orientation prompt text and/or an orientation prompt pattern, and the orientation prompt pattern includes an orientation indication arrow.

On the basis of the above optional technical solutions, the position display module 430 may be configured to, when the picking robot moves to a target picking point, or when a relative distance between the compartment position and the robot position is less than or equal to a preset distance threshold, display, in the preset display interface of the picking robot, the relative position relationship between the compartment position and the robot position.

The position display apparatus according to this embodiment of the present disclosure can perform the position display method according to any one of the embodiments of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

FIG. 7 is a schematic diagram of a structure of a picking robot according to an embodiment of the present disclosure. Referring to FIG. 7 below, it is a schematic diagram of a structure of a picking robot 500 suitable for implementing an embodiment of the present disclosure. The picking robot 500 may be integrated with an electronic device such as a terminal device and/or a server for performing the position display method. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The picking robot shown in FIG. 7 is merely an example, and shall not impose any limitation on the function and scope of use of the embodiments of the present disclosure.

As shown in FIG. 7, the picking robot 500 may include a processing apparatus (e.g., a central processing unit or a graphics processing unit) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the picking robot 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the picking robot 500 to perform wireless or wired communication with other devices to exchange data. Although FIG. 7 shows the picking robot 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 509 and installed, installed from the storage apparatus 508, or installed from the ROM 502. When the computer program is executed by the processing apparatus 501, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The picking robot according to this embodiment of the present disclosure and the status prompt method according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium having stored thereon a computer program that, when executed by a processing apparatus, causes the position display method provided in the above embodiment to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: obtain a picking task that is being executed by the picking robot, and determine, based on the picking task, an item to be picked, where the picking robot includes at least one container for carrying the item to be picked, the picking robot moves between a plurality of shelves in a warehouse to transport items, the shelf includes a plurality of goods storage compartments for storing different items respectively, and the item to be picked is an item that needs to be manually picked; determine a robot position of the picking robot between the shelves and a compartment position of the goods storage compartment where the item to be picked is located; and display, in a preset display interface of the picking robot, a relative position relationship between the compartment position and the robot position.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. Instead, the specific features and actions described above are merely exemplary forms of implementing the claims.

1. A position display method, which is applied to a picking robot, the method comprising:
obtaining a picking task that is being executed by the picking robot, and determining, based on the picking task, an item to be picked, wherein the picking robot comprises at least one container for carrying the item to be picked, the picking robot moves between a plurality of shelves in a warehouse to transport items, the shelf comprises a plurality of goods storage compartments for storing different items respectively, and the item to be picked is an item that needs to be manually picked;
determining a robot position of the picking robot between the shelves and a compartment position of the goods storage compartment where the item to be picked is located; and
displaying, in a preset display interface of the picking robot, a relative position relationship between the compartment position and the robot position.

2. The position display method according to claim 1, wherein the displaying, in a preset display interface of the picking robot, a relative position relationship between the compartment position and the robot position comprises:
displaying a picking region layout map in the preset display interface of the picking robot, wherein the picking region layout map comprises warehouse layout information at the compartment position and at the robot position, and the warehouse layout information comprises at least layout information of the shelves, the goods storage compartments on the shelves, and lanes between the plurality of shelves in the warehouse;
displaying a robot identifier of the picking robot in the picking region layout map based on the robot position; and highlighting the goods storage compartment in the picking region layout map based on the compartment position.

3. The position display method according to claim 2, wherein before the displaying a picking region layout map, the method further comprises:
determining a target picking region based on the compartment position and/or the robot position; and
obtaining a warehouse layout map of the warehouse where the picking robot is located, and using, as the picking region layout map, a local layout map corresponding to the target picking region in the warehouse layout map.

4. The position display method according to claim 3, wherein the determining a target picking region based on the compartment position and/or the robot position comprises:
determining, as the target picking region, a region of a first preset size centered at the compartment position in the warehouse.

5. The position display method according to claim 3, wherein the determining a target picking region based on the compartment position and/or the robot position comprises:
determining, as the target picking region, a region of a second preset size centered at the robot position in the warehouse.

6. The position display method according to claim 3, wherein the determining a target picking region based on the compartment position and/or the robot position comprises:
determining a core region from the warehouse with the compartment position and the robot position as boundary points, and expanding the core region to obtain the target picking region.

7. The position display method according to claim 2, wherein before the displaying a picking region layout map, the method further comprises:
obtaining a warehouse layout map of the warehouse where the picking robot is located, and using the warehouse layout map as the picking region layout map.

8. The position display method according to claim 1, wherein the relative position relationship comprises orientation information of the compartment position relative to the robot position; and the displaying a relative position relationship between the compartment position and the robot position comprises:
determining, based on the robot position and the compartment position, the orientation information of the compartment position relative to the robot position; and
displaying, in the preset display interface of the picking robot, orientation prompt information corresponding to the orientation information.

9. The position display method according to claim 8, wherein the orientation prompt information comprises orientation prompt text and/or an orientation prompt pattern, and the orientation prompt pattern comprises an orientation indication arrow.

10. The position display method according to claim 1, wherein the displaying, in a preset display interface of the picking robot, a relative position relationship between the compartment position and the robot position comprises:
when the picking robot moves to a target picking point, or when a relative distance between the compartment position and the robot position is less than or equal to a preset distance threshold, displaying, in the preset display interface of the picking robot, the relative position relationship between the compartment position and the robot position.

11. The position display method according to claim 1, wherein the displaying, in a preset display interface of the picking robot, a relative position relationship between the compartment position and the robot position comprises:
displaying a picking region layout map in the preset display interface of the picking robot, wherein the picking region layout map comprises warehouse layout information at the compartment position and at the robot position, and the warehouse layout information comprises at least layout information of the shelves, the goods storage compartments on the shelves, and lanes between the plurality of shelves in the warehouse.

12. The position display method according to claim 1, wherein the displaying a picking region layout map in the preset display interface of the picking robot comprise:
when a size of the picking region layout map does not match a size of the preset display interface, performing an image processing on the picking region layout map based on the size of the preset display interface, and the image processing comprises at least one of an image reduction processing, an image enlargement processing, and an image cropping processing.

13. The position display method according to claim 11, wherein before the displaying a picking region layout map, the method further comprises:
determining a target picking region based on the compartment position and/or the robot position; and
obtaining a warehouse layout map of the warehouse where the picking robot is located, and using, as the picking region layout map, a local layout map corresponding to the target picking region in the warehouse layout map.

14. The position display method according to claim 13, wherein the determining a target picking region based on the compartment position and/or the robot position comprises:
determining, as the target picking region, a region of a first preset size centered at the compartment position in the warehouse.

15. The position display method according to claim 13, wherein the determining a target picking region based on the compartment position and/or the robot position comprises:
determining, as the target picking region, a region of a second preset size centered at the robot position in the warehouse.

16. The position display method according to claim 13, wherein the determining a target picking region based on the compartment position and/or the robot position comprises:
determining a core region from the warehouse with the compartment position and the robot position as boundary points, and expanding the core region to obtain the target picking region.

17. The position display method according to claim 2, wherein the highlighting the goods storage compartment in the picking region layout map based on the compartment position comprises:
when the picking region local map is a three-dimensional picking region local map, determining a goods storage compartment corresponding to the compartment position in the three-dimensional picking region local map;
after the goods storage compartment is determined, displaying the goods storage compartment in a preset ratio and/or a preset color in the three-dimensional picking region local map.

18. The position display method according to claim 17, wherein each of the goods storage compartments on the shelf may be marked with a compartment identifier, the compartment identifier of the goods storage compartment is displayed in the preset display interface of the picking robot.

19. A picking robot, comprising:
one or more processors; and
a storage apparatus, configured to store one or more programs, wherein
the one or more programs, when executed by the one or more processors, cause the one or more processors to implement a position display method, wherein the position display method comprise:
obtaining a picking task that is being executed by the picking robot, and determining, based on the picking task, an item to be picked, wherein the picking robot comprises at least one container for carrying the item to be picked, the picking robot moves between a plurality of shelves in a warehouse to transport items, the shelf comprises a plurality of goods storage compartments for storing different items respectively, and the item to be picked is an item that needs to be manually picked;
determining a robot position of the picking robot between the shelves and a compartment position of the goods storage compartment where the item to be picked is located; and
displaying, in a preset display interface of the picking robot, a relative position relationship between the compartment position and the robot position.

20. A non-transitory storage medium, comprising computer-executable instructions, wherein the computer-executable instructions, when executed by a computer processor, are used to perform a position display method, wherein the position display method comprise:
obtaining a picking task that is being executed by the picking robot, and determining, based on the picking task, an item to be picked, wherein the picking robot comprises at least one container for carrying the item to be picked, the picking robot moves between a plurality of shelves in a warehouse to transport items, the shelf comprises a plurality of goods storage compartments for storing different items respectively, and the item to be picked is an item that needs to be manually picked;
determining a robot position of the picking robot between the shelves and a compartment position of the goods storage compartment where the item to be picked is located; and
displaying, in a preset display interface of the picking robot, a relative position relationship between the compartment position and the robot position.
